(19) United States
(12) Patent Application Publication
(10) Pub. No.: US 2015/0141541 A1
(43) Pub. Date: May 21, 2015

(54) COMPOSITION TO PRESERVE INSULATIONS AND SEALANTS AND METHOD

(71) Applicant: Steele Hunter, Harrison, AR (US)

(72) Inventor: Steele Hunter, Harrison, AR (US)

(21) Appl. No.: 14/496,174

(22) Filed: Sep. 25, 2014

Related U.S. Application Data
(62) Division of application No. 13/167,534, filed on Jun. 23, 2011, now abandoned.

(51) Int. Cl. C08K 3/38

(52) U.S. Cl. CPC C08K 3/38; C08K 2003/387
USPC 521/170; 523/122

(57) ABSTRACT

The present invention is generally directed toward the preservation of insulations and sealants and more particularly to the protection of insulation and sealant products against insect attack through the use of inorganic borates. The present invention includes a polymer-based formulation derived from the reaction of an isocyanate component and a resin component. The resin component includes an inorganic borate incorporated therein. The incorporation of the inorganic borate can occur either at the time of the creation of the resin component or at a time after such creation.

### REFERENCE TO PENDING APPLICATIONS

This application claims the benefit of U.S. patent application, Ser. No. 13/167,534 filed Jun. 23, 2011.

### REFERENCE TO MICROFICHE APPENDIX

This application is not referenced in any microfiche appendix.

### BACKGROUND OF THE INVENTION

1. Field of the Invention

The present invention is generally directed toward the preservation of insulations and sealants and more particularly to the protection of insulation and sealant products against insect attack through the use of inorganic borates.

2. Background

Various insects, including the darkling beetle, whose larvae are referred to as lesser mealworms, are a common sight in poultry houses. The presence of these insects has a negative impact on the growth and health of the chicken population. These insects consume chicken feed especially in the periods prior to bird placement.

These insects consume chicken feed, manure, and dead birds and as a result, can harbor a variety of avian pathogens that include but are not limited to Infectious Bursal Disease, Fowl Pox, Newcastle Disease, Marek's Disease and protozoon pathogens. In addition to this they contribute to food safety issues by serving as a source of transmission for Salmonella and Campylobacter. Bugs and beetles are a natural food source for chickens and, as a result, the birds will consume beetles that they find in the house. If beetles are infected with a virus, bacterium or protozoan, their consumption could result in the birds becoming infected or colonized.

In addition to the effect that insects have on chicken performance, the presence of insects can lead to increased heating costs and costly building repairs. Insects burrow into insulation material as they search for a safe pupation site. Insulation board and spray polyurethane insulation appears to be most prone to insect damage. This damage can lead to increased heat loss as well as condensation problems.

One building material that is especially prone to insect damage is polyethylene foam insulation and sealer. In many houses, polyethylene foam sealer is placed on top of the concrete stem wall before the stud wall is constructed to eliminate air leakage. If the sealer is damaged by insects cold air will be drawn through the crack when exhaust fans operate during cold weather, which can lead to decreased bird performance as well as increased likelihood of litter caking.

With recent high fuel prices most chicken producers spend a fair amount of time and money making sure their houses are as tight as possible. One of the most commonly used tools to reduce air leakage is spray polyurethane foam. Though spray polyurethane insulation is extremely effective to reduce air leakage, there is still the problem involving the burrowing of insects into the insulation reducing its ability to seal cracks in just a few of years.

Thus, there is a need for an efficient and effective insulation/sealant that addresses the problem of insect attack.

### BRIEF SUMMARY OF THE INVENTION

The present invention satisfies the needs discussed above. The present invention is generally directed toward the preservation of insulations and sealants and more particularly to the protection of insulation and sealant products against insect attack through the use of inorganic borates.

It is to be understood that the invention is not limited in its application to the details of the construction and arrangement of parts illustrated in the accompanying drawings. The invention is capable of other embodiments and of being practiced or carried out in a variety of ways. It is to be understood that the phraseology and terminology employed herein are for the purpose of description and not of limitation.

One aspect of the present invention is directed toward a composition, and related method, having a polymer-based formulation derived from the reaction of an isocyanate component and a resin component. The resin component includes an inorganic borate incorporated therein.

The inclusion of the inorganic borate into the resin component can be accomplished by either including it with the individual ingredients at the time of the mixing and creating of the resin component or adding it to existing resin through normal mixing methods such as molecular shearing.

Upon reading the above description, various alternative embodiments will become obvious to those skilled in the art. These embodiments are to be considered within the scope and spirit of the subject invention, which is only to be limited by the claims which follow and their equivalents.

### DESCRIPTION OF THE INVENTION

The present invention satisfies the needs discussed above. The present invention is generally directed toward the preservation of insulations and sealants and more particularly to the protection of insulation and sealant products against insect attack through the use of inorganic borates.

One embodiment of the present invention comprises a polymer-based formulation derived from the reaction of an isocyanate component and a resin component. The resin component includes an inorganic borate incorporated therein.

The polymer-based formulation of this invention can be prepared by well known blending or mixing methods for two-part polymer compositions. The incorporation of the inorganic borate can occur either at the time of the creation of the resin component or at a time after such creation. In such a case, the blending and mixing of the resin component and inorganic borate can be performed by standing mixing and blending processes including molecular shearing.

The inorganic borate which are combined to be used in this embodiment may be any one or more of the alkali metal borates such as the sodium borates, sodium polyborate, sodium tetraborate borax pentahydrate, sodium pentaborate borax decahydrate, disodium octaborate, sodium metaborate, boracic acid, orthoboric acid and acidum boricum. Additionally, the inorganic borates may be synthetically produced or may be a naturally occurring borate, such as tincal, tincalconite or kernite.

The basis for the polymer-based formulation can be polyurethane-based, polyurea-based formulation or other suitable formulation. Additionally, the formulation can produce various products, including closed cell spray foam insulation formulation, closed cell spray foam sealant formulation, closed cell pour foam insulation formulation and closed cell pour foam sealant formulation.

The particle size of the inorganic borates is not critical, but should be of a size that can be readily dispersed throughout the composite product.

The effective amount of inorganic borates incorporated in the composite is a pesticidal amount; that is, an amount sufficient to control or kill insects that destroy the composite or inhabit chicken houses. The amount used will depend on the target pests and desired performance longevity.

The inorganic borates may be incorporated in the composite in any manner that will result in dispersion throughout the final product. Preferably, the inorganic borates are evenly distributed throughout the resin in order to maximize insect control effectiveness

While the invention has been described with a certain degree of particularity, it is manifest that many changes may be made in the details of construction and the arrangement of components without departing from the spirit and scope of this disclosure. It is understood that the invention is not limited to the embodiments set forth herein for purposes of exemplification.

1. A composition comprising a polymer-based formulation derived from the reaction of an isocyanate component and a resin component, said resin component having an inorganic borate incorporated therein.

2. A method for protecting a polymer-based formulation against insect attack wherein said polymer-based formulation is derived from the reaction of an isocyanate component and a synthetic resin blend component, said method comprising incorporating an inorganic borate into the synthetic resin blend component prior to the incorporation of said isocyanate component and a synthetic resin blend component.

3. The method of claim 2 wherein said polymer-based formulation is a closed cell spray foam insulation formulation.

4. The method of claim 2 wherein said polymer-based formulation is a closed cell pour foam insulation formulation.

5. The method of claim 2 wherein said polymer-based formulation is a closed cell pour foam sealant formulation.

6. The method of claim 2 wherein said inorganic borate is selected from the group consisting of sodium polyborate, sodium tetraborate, sodium borate, boracic acid, orthoboric acid and acidum boricum.

7. The method of claim 2 wherein said polymer-based formulation is defined as a polyurethane-based formulation.

8. The method of claim 2 wherein said polymer-based formulation is defined as a polyurea-based formulation.

9. The method of claim 2 wherein said incorporating an inorganic borate into the synthetic resin blend component is performed after said synthetic resin blend component has been created and wherein said incorporated is performed through molecule shearing and blending of said inorganic borate with said synthetic resin blend component.

10. The method of claim 2 wherein said incorporating an inorganic borate into the synthetic resin blend component is performed at the time of the creation of said synthetic resin blend component by incorporating said inorganic borate with the individual ingredients making up said synthetic resin blend component.
